(19) United States
(12) Patent Application Publication
(10) Pub. No.: US 2011/0316401 A1
(43) Pub. Date: Dec. 29, 2011

(54) Front Frame Hinge For Appliance Door

(75) Inventors: Steven Cummins, Mansfield, OH (US); Brian White, Shelby, OH (US); James Collene, Bucyrus, OH (US); Bruce Cummins, Mansfield, OH (US)

(73) Assignee: Mansfield Assemblies Co.,, Mansfield, OH (US)

(21) Appl. No.: 13/115,857

(22) Filed: May 25, 2011

Related U.S. Application Data
(60) Provisional application No. 61/347,957, filed on May 25, 2010.

(51) Int. Cl. A47B 96/00; E05D 11/04; E05F 1/12

(52) U.S. Cl. 312/319.2; 16/303; 16/275

(57) ABSTRACT

A hinge assembly includes a base and a lever pivotally connected to the base. The lever includes an outer end adapted for being connected to an associated appliance door and an inner end. A cam is pivotally connected to the inner end of the lever and includes a contoured lobe edge. A cam control member is connected to the base. A spring includes a first end connected to the cam. The spring exerts a biasing force on the cam in a first direction such that said lever is urged toward a first position and said contoured lobe edge of said cam is urged into abutment with the cam control member. The lever is selectively movable from its first position against the biasing force of the spring to a second position. The cam control member contacts a first portion of the contoured lobe edge when the lever is located in its first position, and the cam control member contacts a second portion of the contoured lobe edge when the lever is located in its second position.

### CROSS-REFERENCE TO RELATED APPLICATION

This application claims priority from and benefit of the filing date of U.S. provisional patent application Ser. No. 61/347,957 filed May 25, 2010, and said provisional patent application is hereby expressly incorporated by reference into the present specification.

### BACKGROUND

Various types of hinge assemblies for oven doors and other appliance applications are known. Appliance manufacturers and users are continuously seeking new and improved hinge assemblies that provide optimal performance, durability, affordable cost, and ease of assembly and repair. Known hinge assemblies generally meet these requirements, but it has been deemed desirable to provide a new and improved appliance hinge assembly that provides improvements with respect to these and other criteria.

### SUMMARY

In accordance with one aspect of the present development, a hinge assembly includes a base and a lever pivotally connected to the base. The lever includes an outer end adapted for being connected to an associated appliance door and an inner end. A cam is pivotally connected to the inner end of the lever and includes a contoured lobe edge. A cam control member is connected to the base. A spring includes a first end connected to the cam. The spring exerts a biasing force on the cam in a first direction such that said lever is urged toward a first position and said contoured lobe edge of said cam is urged into abutment with the cam control member. The lever is selectively movable from its first position against the biasing force of the spring to a second position. The cam control member contacts a first portion of the contoured lobe edge when the lever is located in its first position, and the cam control member contacts a second portion of the contoured lobe edge when the lever is located in its second position.

In accordance with another aspect of the present development, a hinge assembly includes a base and a lever pivotally connected to the base. The lever includes: (i) an outer end adapted for being connected to an associated appliance door; and (ii) an inner end. A cam is pivotally connected to the inner end of the lever. The cam includes a contoured lobe edge. A cam control member is connected to the base. The hinge assembly includes biasing means for urging the cam in a first direction such that the contoured lobe edge of the cam is urged into abutment with the cam control member. The lever is selectively movable from its first position to a second position. The cam control member contacts a first portion of the contoured lobe edge when the lever is located in its first position, and contacts a second portion of the contoured lobe edge when said lever is located in its second position.

In accordance with another aspect of the present development, an appliance includes a body with a chamber. First and second hinge assemblies are connected to the body respectively adjacent first and second opposite lateral sides of the chamber. A door is connected to the first and second hinge assemblies and is movable relative to the body between a closed position and an opened position. At least one of the first and second hinge assemblies includes a base and a lever pivotally connected to the base. The lever includes: (i) an outer end connected to the door; and (ii) an inner end. A cam is pivotally connected to the inner end of the lever and includes a contoured lobe edge. A cam control member is provided. Biasing means urge the contoured lobe edge of the cam into abutment with the cam control member. The lever is selectively movable from the first position to a second position. The cam control member contacts a first portion of the contoured lobe edge when the lever is located in its first position, and contacts a second portion of the contoured lobe edge when the lever is located in its second position.

### BRIEF DESCRIPTION OF THE DRAWINGS

FIG. 1 is an isometric view of an appliance (oven) including first and second hinge assemblies formed in accordance with the present development, with the appliance door in a fully opened position (a side panel of the appliance is removed to reveal part of the first hinge assembly);

FIG. 2 is a side view of the appliance of FIG. 1;

FIG. 3 is an enlarged side view similar to FIG. 2, but showing the appliance door in its closed position;

FIG. 4 is a side view similar to FIG. 3, but shows the appliance door in a partially opened position;

FIG. 5 is a side view of a hinge assembly formed in accordance with the present development, with the hinge assembly in its first position corresponding to the door closed position of the appliance;

FIG. 6 is similar to FIG. 5, but shows the hinge assembly in its second position corresponding to the associated appliance door being fully opened;

FIG. 7A is a front view of the hinge assembly of FIG. 5 (with the spring omitted for clarity);

FIG. 7B is a section view as taken at line B-B of FIG. 7A.

FIGS. 8, 9 and 10 are isometric views of the hinge assembly of FIG. 5 (with the spring omitted for clarity) that respectively show the hinge assembly in its first position, an intermediate position, and its second position.

FIG. 11 illustrates a door removal or installation position/configuration of the hinge assembly.

### DETAILED DESCRIPTION

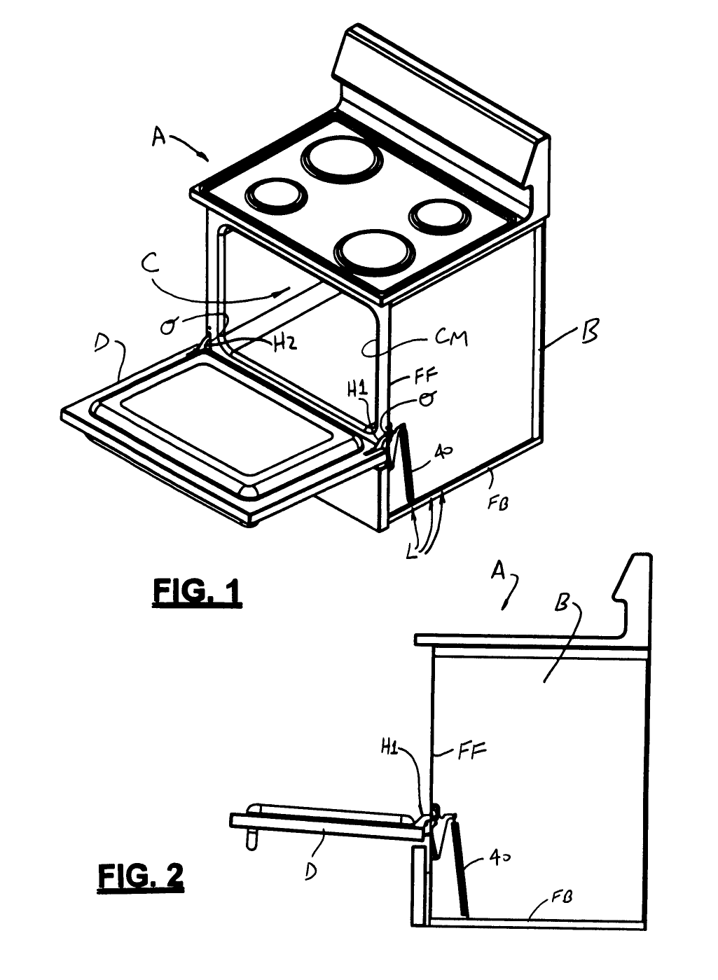

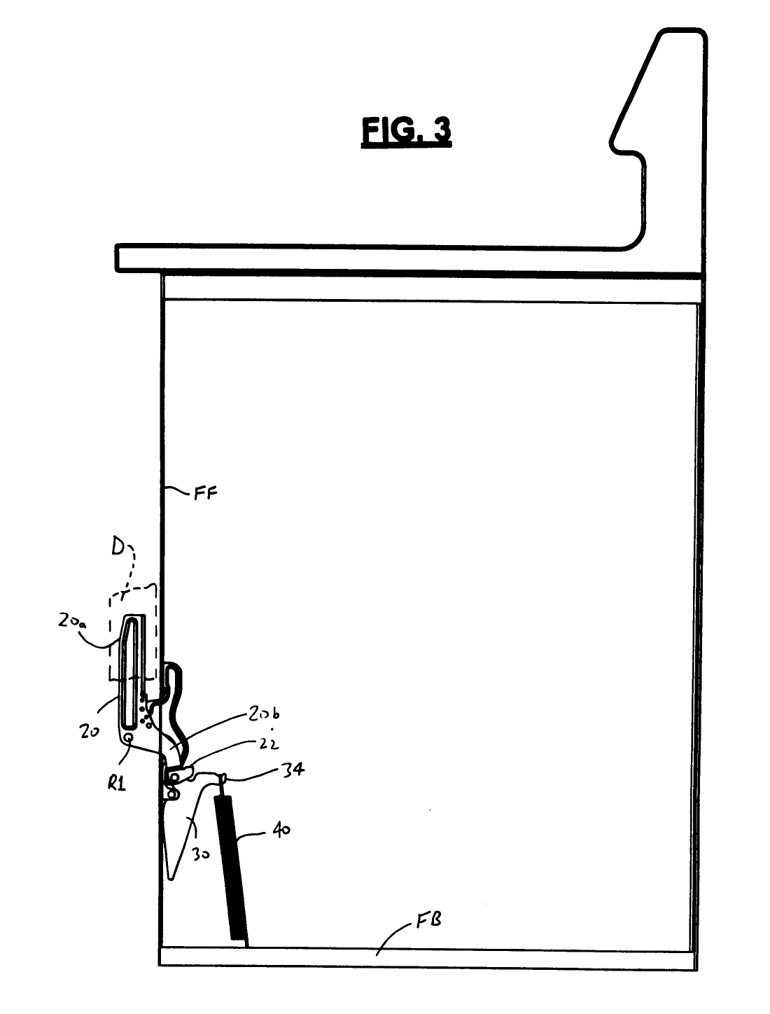

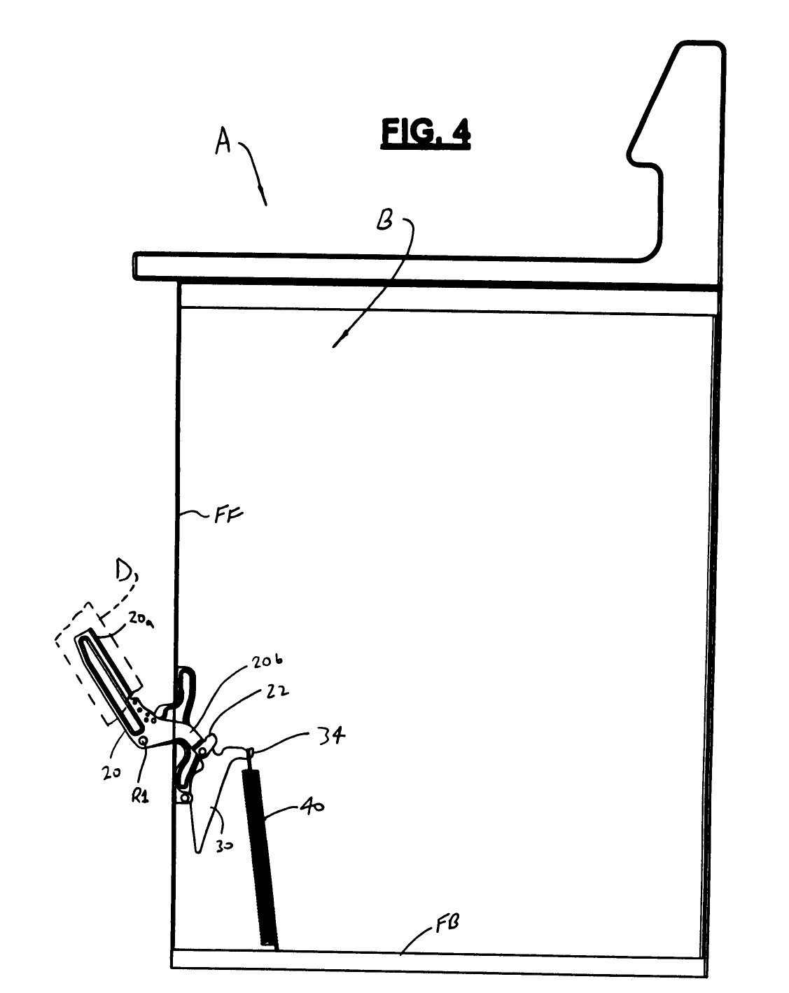

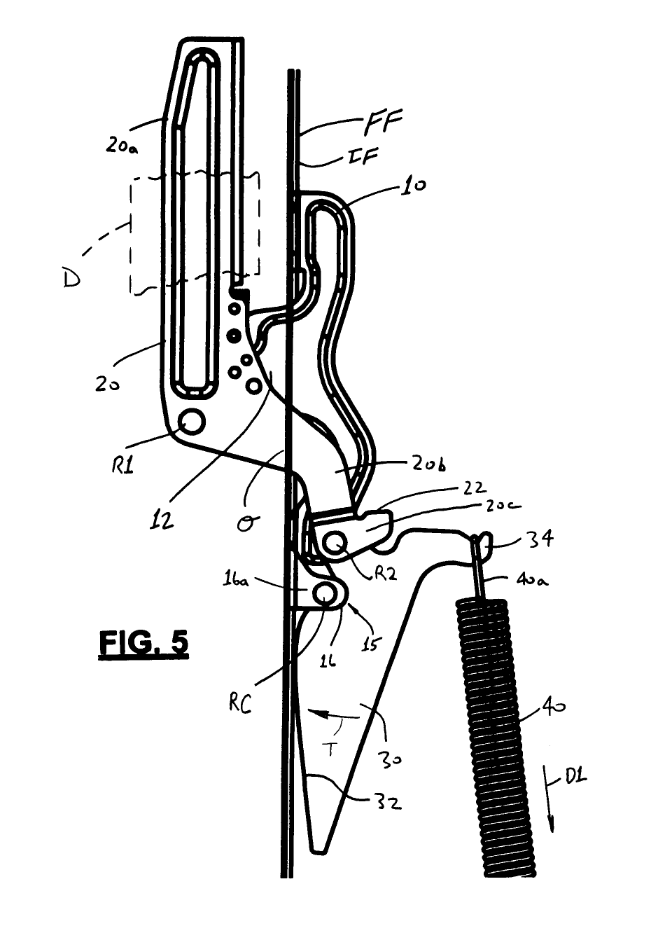

FIGS. 1-4 show an appliance (e.g., an oven or dryer) A including a body B defining a cooking/drying or other internal chamber C and a door D that moves between a closed position (FIG. 3), where the door D is generally vertically oriented and closes an open mouth CM of the chamber C and blocks access to the chamber, and various opened positions including a fully opened position (FIGS. 1 and 2) where the door is generally horizontally positioned and allows access into the chamber C through its open mouth CM. The appliance A includes first and second hinge assemblies H1,H2 respectively located adjacent opposite first and second lateral sides of the chamber C. The hinge assemblies H1,H2 are each connected to a front frame FF of the body B (a side wall of the body B is removed in the drawings to reveal portions of the hinge assembly H1 located inside the body B). Opposite first and second lateral sides of the door D are respectively connected to the first and second hinge assemblies H1,H2, and the hinge assemblies H1,H2 are constructed to allow the door to pivot between its closed and opened positions.

At least one of the hinge assemblies H1,H2 is constructed in accordance with the present development. As shown herein, both hinge assemblies H1,H2 are constructed in accordance with the present development, although the structure and operation of the hinge assemblies H1,H2 is explained herein with reference only to the hinge assembly H1. Those of ordinary skill in the art will recognize that the hinge assembly H2 is identical to the hinge assembly H1 and/or the hinge assembly H2 is otherwise formed in accordance with the present development as described herein.

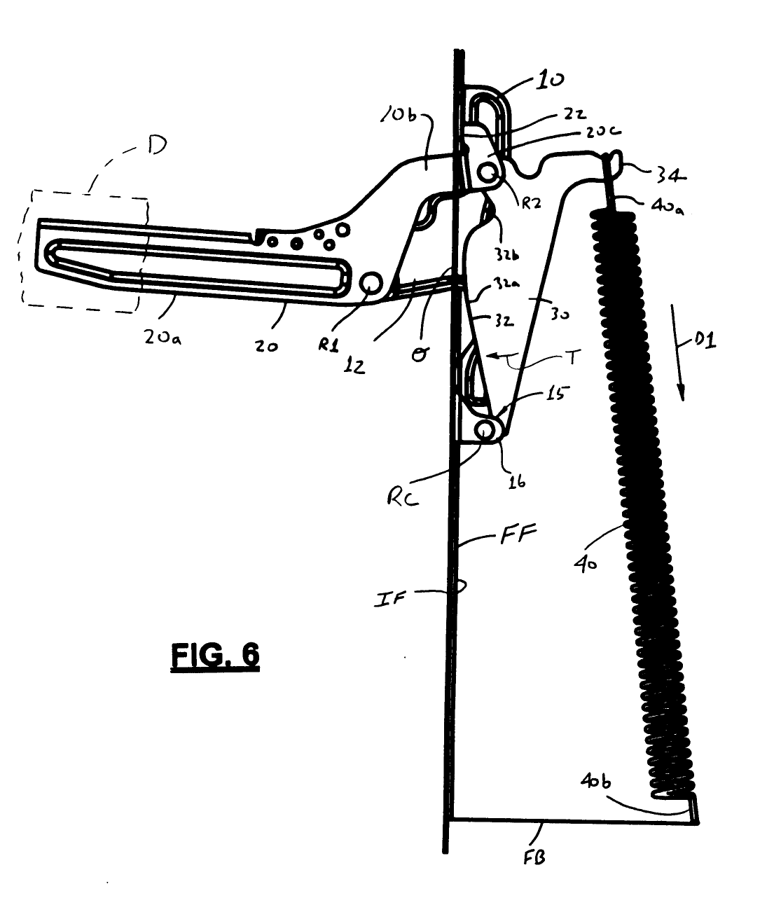

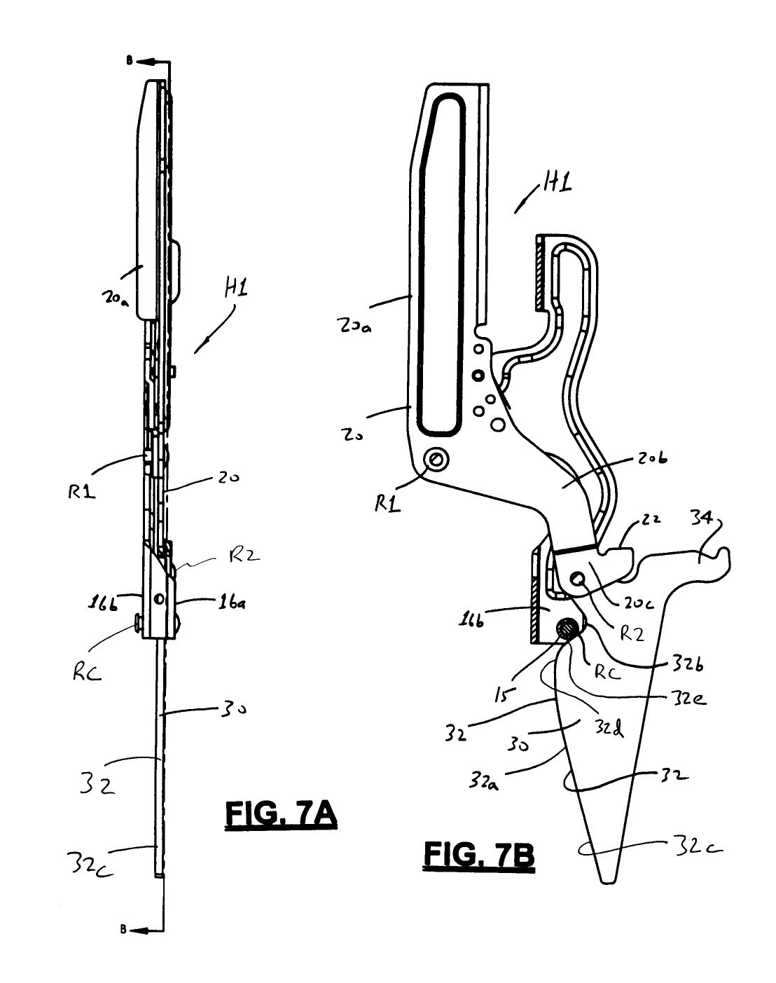

Referring now also to FIGS. 5 and 6, the hinge assembly H1 comprises a base or channel 10 that is fixedly secured adjacent an internal face IF the appliance front frame FF inside the appliance body B. The base 10, which can have a wide variety of shapes, includes a tab 12 that projects outwardly through an opening O (FIG. 1) defined in the front frame FF so as to be located external to the body B.

A door-mounting lever 20 is pivotally connected to the tab 12 using a first pivot fastener R1 such as a rivet or pin or other pivot fastener. The oven door D is mounted to a first or outer end 20a of the lever 20 that is located outside the appliance body B. The lever 20 includes a second or inner end or tail 20b at least part of which extends through the opening O so as to project into the appliance body B. The first pivot fastener R1 separates the first end 20a of the lever from the second end 20b of the lever. The lever 20 pivots about a horizontal pivot axis defined by the first pivot fastener to and between a first position (FIG. 5) corresponding to the oven door D being fully closed and a second position (FIG. 6) corresponding to the oven door D being fully opened. The tail 20b of the lever includes/defines a tab or stop portion 22 that abuts the body front frame FF and/or base 10 or other fixed location when the lever 10 is in its second position corresponding to the oven door D being fully opened.

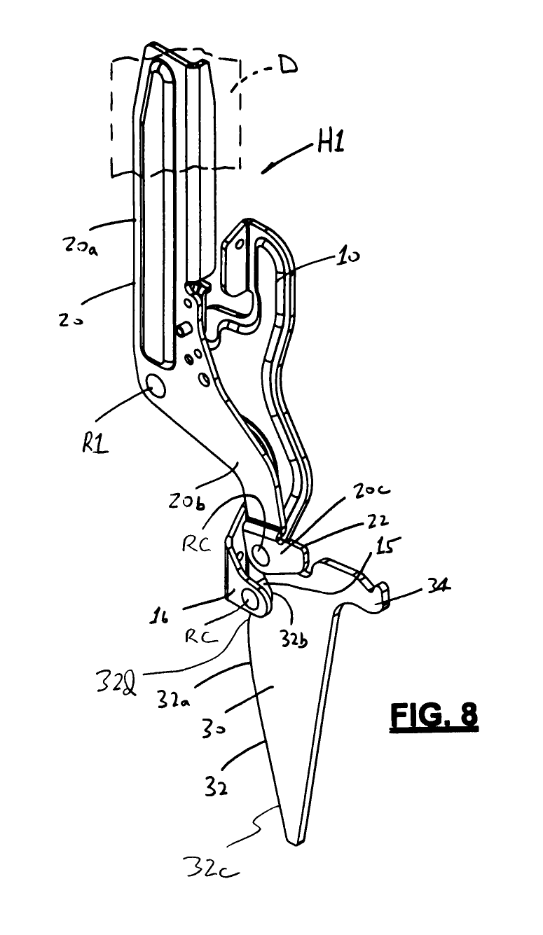

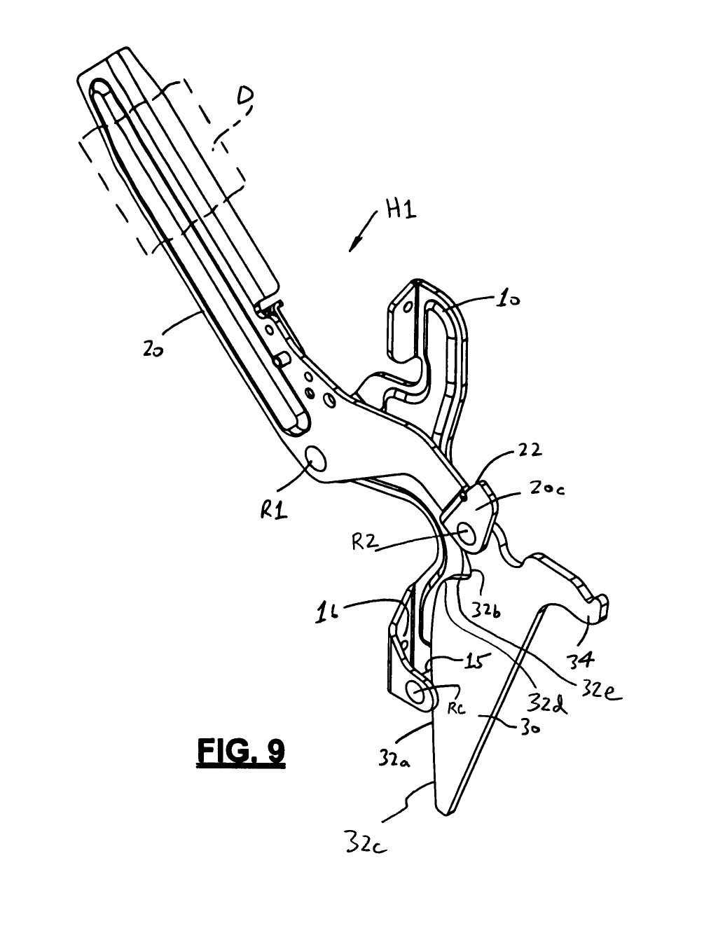

Referring also to FIGS. 7A and 7B, a roller, bushing, or other cam follower or cam control member 15 is mounted to the base 10 inside the appliance body B. As shown the base 10 defines a U-shaped or otherwise shaped mounting portion 16 including spaced-apart side walls 16a,16b, and the cam control member 15 comprises a rotatable roller that is rotatably mounted between the side walls 16a,16b using a rivet RC or other fastener. Alternatively, the cam control member 15 comprises a non-rotatable slide member or bushing defined from a low-friction metal or polymeric material.

A cam 30 is pivotally connected to a distal end 20c or other portion of the lever tail 20b that is located inside the appliance body B by a second pivot fastener R2 such as a rivet, pin or other pivot fastener. The cam 30 includes a contoured lobe edge 32 that abuts the cam control member 15. The lobe edge 32 has a profile that includes a working portion 32a that is gently curved and a dwell point 32b defined by a deep concave recess. A first end of the working portion 32a is connected to and blends/transitions smoothly into the dwell point 32b by a convexly curved portion 32d, and a second end 32c of the working portion 32a is spaced from the dwell point 32b. The cam 30 moves or translates relative to the cam control member 15 in a first (downward) direction and an opposite second (upward) direction D2. In particular, when the lever 20 pivots from its first (door closed) position toward its second (door opened) position, the cam 30 moves relative to the cam control member 15 in the second direction D2, and when the lever 20 pivots from its second (door opened) position toward its first (door closed) position, the cam 30 moves relative to the cam control member 15 in the first direction D1.

The hinge assembly H1 further comprises a biasing spring 40 for urging the cam lobe edge 32 into abutment with the cam follower 15 and for biasing the lever 20 toward its first (door-closed) position. In the illustrated embodiment, the cam 30 includes a projection such as a spring arm 34 that extends away from the second pivot fastener rivet R2 on a side opposite the lobe edge 32 and that provides a location that is engaged with a first end 40a of the biasing spring 40, e.g., such as by a hook or loop formed in the first end 40a of the spring. An opposite, second end 40b of the biasing spring 40 is connected to a fixed anchor location such as a base FB or other part of the appliance body B. As shown in FIGS. 5 and 6, the location of the second pivot fastener R2 between the lobe edge 32 and the spring arm 34 is such that it acts as a pivot point or axis of rotation for the cam 30. Biasing force exerted by the spring 40 on the spring arm 34 portion of the cam 30 in the first direction D1 establishes a torque or moment of force (moment) T that causes the cam 30 to rotate or pivot about the second pivot fastener R2 so that the contoured lobe edge 32 of the cam is urged continuously into abutment with the cam control member 15. The spring biasing force in the first direction D1 also urges the lever 20 toward its first (door closed) position because of the force exerted on the cam 30 in the direction D1 by the spring and the action of the cam lobe edge 32 against the cam control member 15. In one embodiment, the appliance body B includes multiple possible anchor locations L (FIG. 1) to which the second end 40b of the biasing spring 40 can be releasably connected, e.g., by a hook or the like formed on the second end 40b of the spring, and the connection location L between the second end 40b of the spring 40 and the appliance body B is varied to adjust the tension or preload exerted by the spring 40 on the spring arm 34 of the cam 30. In another embodiment, the base 10 includes a projection or other location to which the second end 40b of the spring 40 is connected.

FIG. 7A is a front view of the hinge assembly H1, and FIG. 7B is a section view as taken at line B-B of FIG. 7A. The spring 40 is omitted from FIGS. 7A and 7B. The section view of FIG. 7B illustrates engagement of the cam lobe edge 32 with the cam control member 15, with the lever 20 in its first (door closed) position. The hinge assembly H1 is constructed such that when the lever 20 is in its first position, the cam control member 15 is engaged with a sloped edge 32e of the dwell point 32b such that the biasing force of the spring 40 in conjunction with the action of the cam control member 15 on the transition edge 32e will cause the cam 30 to be urged downward in the direction D1 and toward the cam control member 15 which urges the door-mounting lever 20 toward its first (door closed) position to provide a good pull-in force to ensure that the appliance door D effectively seals the open mouth CM of the chamber C.

The base 10, lever 20 and cam 30 are typically defined from respective metal stampings or other metal structures, although polymeric or other materials could be used depending upon the type of appliance A and the temperature and other environmental conditions to which the hinge assembly H1 will be exposed. As shown herein, the base 10, lever 20 and cam 30 are defined by respective one-piece metal stampings, but other metal or polymeric one-piece or multi-piece structures are contemplated. In the illustrated embodiment, the spring is a steel coil spring but it is not intended that the present development be limited to any particular material for the spring 40.

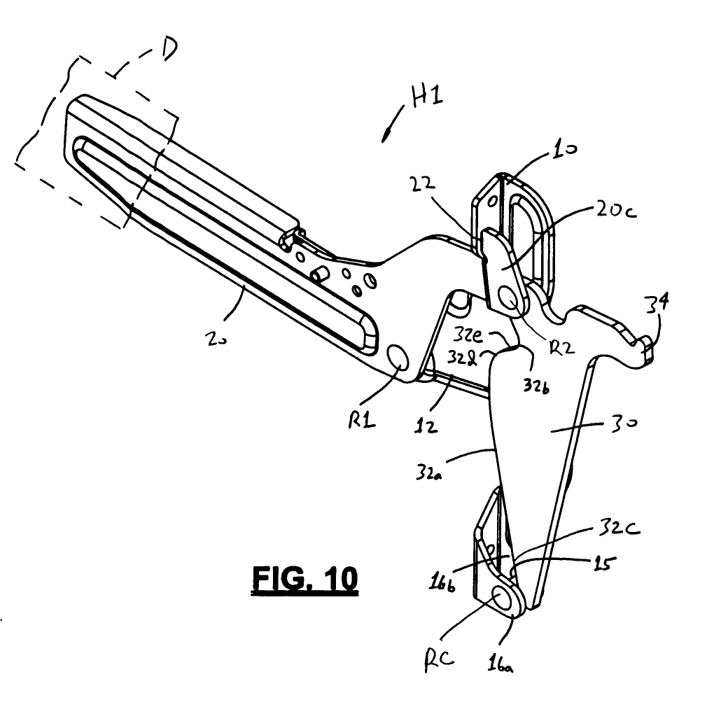

FIGS. 8, 9 and 10 are isometric views of the hinge assembly H1 (omitting the spring 40) that show operation of the hinge assembly to allow opening and closing of the oven door D in cooperation with another like or different hinge assembly H2. FIG. 8 shows the lever 20 in its first position corresponding to the oven door D being closed. The cam 30 is positioned such that the cam control member 15 is located in contact with the transition edge 32e of the dwell point 32b, and the biasing force of the spring 40 (not shown) inhibits movement of the lever 20 away from its first position toward its second (door opened) position.

FIG. 9 shows the lever 20 moved to an intermediate position between its first and second positions in response to manual movement of the door D by a user of the appliance A. The cam 30 has moved to a position where the cam control member 15 is abutted with the working portion 32a of the lobe edge 32. Although not shown herein, the working portion 32a can comprise a broil stop dwell point that receives and releasably retains the cam control member 15 to hold the door D in a partially opened broil position against the biasing force of the spring 40 until the door D is manually moved toward either its fully opened or closed position by a user.

FIG. 10 shows the lever 20 moved to its second position where the appliance door D is fully opened. The stop 22 of the lever is abutted with the base 10, which prevents pivoting movement of the lever 20 away from its first position beyond the second position. The cam 30 is positioned such that the cam control member 15 is engaged with the second end 32c of the working portion 32a that is spaced from the dwell point 32b. The weight of the door D will hold the lever 20 in its second position.

It can be seen that pivoting movement of the lever 20 between its first and second positions induces corresponding translational movement of the cam 30 relative to the cam control member 15, such that the cam control member 15 is in contact with a different portion of the contoured lobe edge 32 for each angular position of the lever 20.

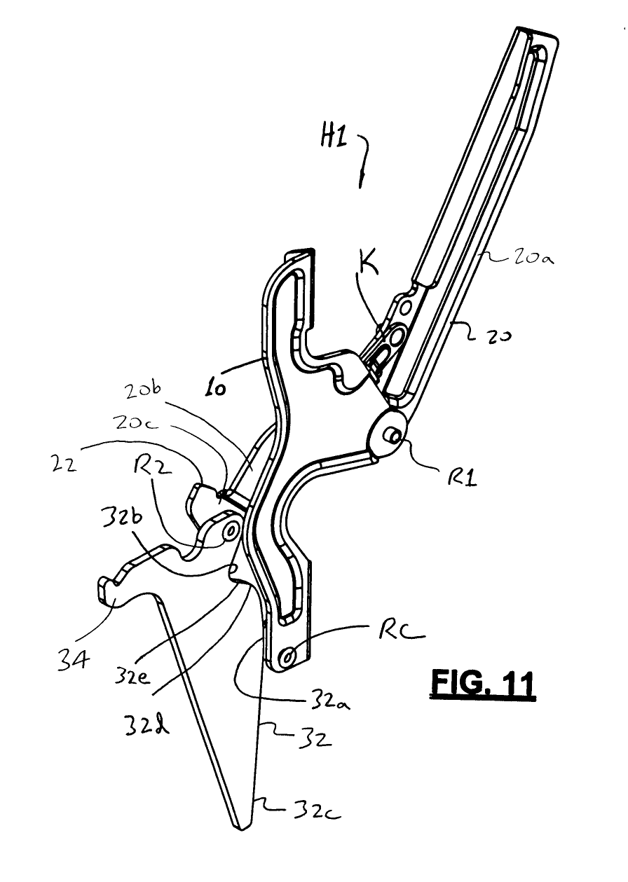

FIG. 11 illustrates a maintenance position/configuration of the hinge assembly H1. The hinge assembly H1 includes a latch K that is pivotally or otherwise movably connected to the lever 20 (as shown) and/or base 10. Normally, the latch K is located in a recessed position (FIGS. 1-10) where it has no effect on the operation of the hinge assembly. FIG. 11 shows that the latch K is selectively manually movable to an extended position where it is located to abut the base 10 and block movement of the lever 20 to its first position (if the latch K is movably connected to the base 10, it abuts the lever 20 when moved to its extended position). With the latch K extended and the lever prevented from moving to its first (door closed position), the hinge assembly H1 is located in its maintenance position where the door D can be separated from the lever 20 as required for maintenance.

The tension coil spring 40 can be replaced by a compression coil spring or any other mechanical and/or fluid charged (gas/oil/pneumatic/etc.) spring or other suitable biasing means that will bias the lever 20 and cam 30 of the hinge assembly H1 as described herein. For example, the spring 40 can be replaced by a fluid-charged strut that uses a gas and/or liquid biasing fluid, a spring-loaded damper and/or any other spring means or biasing means, and it is not intended that the present development be limited to the illustrated spring 40.

Other modifications and alterations will occur to those of ordinary skill in the art to which the invention pertains upon reading and understanding this specification. It is intended that the present invention, as defined by claims, be construed as encompassing all such modifications and alterations.

1. A hinge assembly comprising:
a base;
a lever pivotally connected to the base, said lever including: (i) an outer end adapted for being connected to an associated appliance door; and (ii) an inner end;
a cam pivotally connected to the inner end of the lever, said cam comprising a contoured lobe edge;
a cam control member connected to the base;
a spring comprising an first end connected to the cam, said spring exerting a biasing force on said cam in a first direction such that said lever is urged toward a first position and said contoured lobe edge of said cam is urged into abutment with the cam control member;
said lever selectively movable from said first position against said biasing force of said spring to a second position, said cam control member contacting a first portion of said contoured lobe edge when said lever is located in its first position, and contacting a second portion of said contoured lobe edge when said lever is located in its second position.

2. The hinge assembly as set forth in claim 1, wherein:
said lever is pivotally connected to said base by a first pivot fastener located between said outer end of said lever and said inner end of said lever;
said inner end of said lever is pivotally connected to said cam by a second pivot fastener.

3. The hinge assembly as set forth in claim 2, wherein said first end of said spring is connected to said cam on a first side of said second pivot fastener and said contoured lobe edge of said cam is located on a second side of said second pivot fastener, such that said biasing force of said spring exerts torque on said cam that urges said contoured lobe surface of said cam into abutment with said cam control member.

4. The hinge assembly as set forth in claim 3, wherein:
said first portion of said contoured lobe edge of said cam comprises a working portion; and,
said second portion of said contoured lobe edge of said cam comprises a dwell point.

5. The hinge assembly as set forth in claim 4, wherein a first end of the working portion is connected to and blends into said dwell point by a convexly curved transition portion.

6. The hinge assembly as set forth in claim 5, wherein said dwell point comprises a sloped edge with which said cam control member is in contact when said lever is located in its first position, wherein said contact between said cam control member and said sloped edge in response to said moment of force exerted on said cam by said spring urges said cam in said first direction and urges said lever toward its first position.

7. The hinge assembly as set forth in claim 3, wherein said cam control member comprises a roller secured to said base.

8. The hinge assembly as set forth in claim 7, wherein said base comprises a mounting portion including spaced-apart side walls, and said roller is rotatably secured between said first and second spaced-apart side walls of said mounting portion.

9. The hinge assembly as set forth in claim 3, wherein said inner end of said lever comprises a stop portion that abuts said base when said lever is moved to its second position.

10. The hinge assembly as set forth in claim 1, further comprising a latch movably connected to one of said lever and said base, said latch selectively movable from a recessed position to an extended position, wherein said latch blocks movement of said lever from said second position to said first position when said latch is in said extended position.

11. The hinge assembly as set forth in claim 1, further comprising an appliance body to which said hinge assembly is connected, wherein a second end of said spring is connected to said appliance body.

12. The hinge assembly as set forth in claim 11, wherein said appliance body comprises multiple anchor locations, and said second end of said spring is connected to one of said multiple anchor locations, wherein said spring comprises a preload tension that varies according to which of said multiple anchor locations said second end of said spring is connected.

13. A hinge assembly comprising:
a base;
a lever pivotally connected to the base, said lever including: (i) an outer end adapted for being connected to an associated appliance door; and (ii) an inner end;
a cam pivotally connected to the inner end of the lever, said cam comprising a contoured lobe edge;
a cam control member connected to the base;
biasing means for urging said cam in a first direction such that said contoured lobe edge of said cam is urged into abutment with the cam control member;
said lever selectively movable from said first position to a second position, said cam control member contacting a first portion of said contoured lobe edge when said lever is located in its first position, and contacting a second portion of said contoured lobe edge when said lever is located in its second position.

14. An appliance comprising:
a body including a chamber;
first and second hinge assemblies connected to said body respectively adjacent first and second opposite lateral sides of said chamber;
a door connected to said first and second hinge assemblies and movable relative to said body between a closed position and an opened position;
at least one of said first and second hinge assemblies comprising:
a base;
a lever pivotally connected to the base, said lever including: (i) an outer end connected to the door; and (ii) an inner end;
a cam pivotally connected to the inner end of the lever, said cam comprising a contoured lobe edge;
a cam control member;
biasing means for urging said contoured lobe edge of said cam into abutment with the cam control member;
said lever selectively movable from said first position to a second position, said cam control member contacting a first portion of said contoured lobe edge when said lever is located in its first position, and contacting a second portion of said contoured lobe edge when said lever is located in its second position.
